(19) United States
(12) Patent Application Publication
(10) Pub. No.: US 2009/0224881 A1
(43) Pub. Date: Sep. 10, 2009

(54) DIGITAL WEATHER STATION

(75) Inventors: Jeffrey David Koon, Lombard, IL (US); Michael Manion, McHenry, IL (US); Elizabeth Wentland, Chicago, IL (US); Ronni L. Emrich, Norridge, IL (US)

Correspondence Address: BROOKS KUSHMAN P.C., 1000 TOWN CENTER, TWENTY-SECOND FLOOR, SOUTHFIELD, MI, 48075, US

(73) Assignee: TAYLOR PRECISION PRODUCTS, INC., Oak Brook, IL (US)

(21) Appl. No.: 12/397,388

(22) Filed: Mar. 4, 2009

Related U.S. Application Data
(60) Provisional application No. 61/033,935, filed on Mar. 5, 2008.

(51) Int. Cl. H04Q 1/00

(52) U.S. Cl. 340/7.48

(57) ABSTRACT

A digital weather station for displaying weather related information. The digital weather station includes an electronic connection unit configured to receive weather data relating to a number of weather parameters, a processing unit configured to process the weather data relating to the number of weather parameters to determine a number of weather related health indicators, and a display unit configured to display the number of weather related health indicators.

### CROSS-REFERENCE TO RELATED APPLICATIONS

This application claims the benefit of U.S. provisional application Ser. No. 61/033,935 filed Mar. 5, 2008, which is incorporated by reference in its entirety.

### BACKGROUND

1. Technical Field

One or more embodiments relate to digital weather stations.

2. Background Art

Digital weather stations are primarily used to measure and display indoor and outdoor weather parameters that include barometric pressure, temperature, humidity, wind speed/direction and rain accumulation. The digital weather station may also use the weather parameters in order to predict weather trends.

### BRIEF DESCRIPTION OF THE DRAWINGS

FIG. 1 is a perspective view depicting a digital weather station system according to one or more embodiments;

FIG. 2 shows a number of images depicting number of outdoor allergy indicator levels according to one or more embodiments;

FIG. 3 shows a number of images depicting a number of indoor allergy indicator levels according to one or more embodiments;

FIG. 4 shows a number of images depicting a number of aches and pains indicator levels according to one or more embodiments;

FIG. 5 shows a number of images depicting a number of outdoor fitness indicator levels according to one or more embodiments;

FIG. 6 shows a number of images depicting a number of insect indicator levels according to one or more embodiments; and

FIG. 7 shows a number of images depicting a number of skin protection indicator levels according to one or more embodiments.

### DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present invention.

Digital weather stations are primarily used to measure and display indoor and outdoor weather parameters that include barometric pressure, temperature, humidity, wind speed/direction and rain accumulation. The digital weather station may also use the weather parameters in order to predict weather trends. However, current digital weather stations do not illustrate and alert a user of weather indicative general health conditions in a given area proximate the digital weather station. In light of the foregoing, the applicants have devised a digital weather station with weather indicative general conditions of health in a given area.

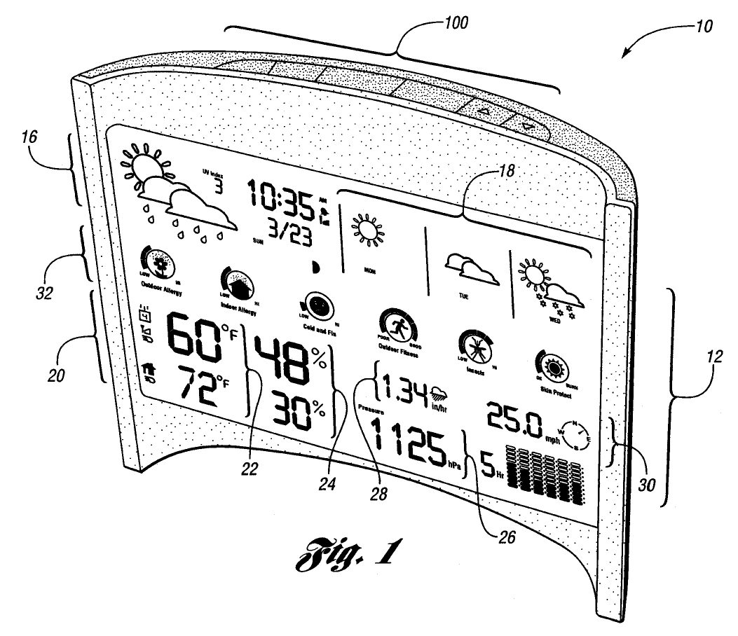

In light of the foregoing, FIG. 1 is a perspective view depicting a digital weather station 10 according to one embodiment. The digital weather station 10 may electronically communicate with a computer (not shown) in order to receive weather parameters from an internet website. For example, the computer may communicate with websites such as www.foreca.com, weatherbug.com, weather.com, weather.yahoo.com or any other suitable weather related website. The digital weather station 10 may further include a receiver (not shown) that receives the weather parameters and a microprocessor (not shown) that correspondingly performs calculations so that the information may be illustrated to the user on the display 12. The computer may electronically communicate with the digital weather station 10 using an ethernet, USB, Firewire, serial connection or any other suitable electronic connection. Alternatively, the computer may wirelessly communicate with the digital weather station 10 using WiFi, wireless USB, or any other suitable wireless connection.

The digital weather station 10 may wirelessly communicate and receive the weather parameters from a subscriber service. For example, the digital weather station 10 may wirelessly communicate and receive the weather parameters from a satellite, a Digital/Hi-definition radio, a cable provider or the like. The microprocessor may use the weather parameters received from the subscriber service and correspondingly perform calculations and illustrate the weather information to the user on the display 12.

Alternatively, the digital weather station 10 may receive the weather parameters from any number of remote sensors (not shown). The remote sensors may be capable of measuring various weather parameters that include pressure, temperature, humidity, precipitation, UV index, wind speed and the like. The remote sensors may be placed in an outdoor or indoor location and may electronically communicate the weather parameters to the digital weather station 10. For example, the remote sensors may wirelessly transmit the sensed weather parameters to the digital weather station 10. Upon receiving the sensed weather parameters, the microprocessor may perform calculations and illustrate the weather information to the user on the display 12.

The sensors may also be included within the digital weather station 10. As such, the digital weather station 10 may be capable of monitoring indoor or outdoor weather parameters depending on the location of the digital weather station 10. The sensors may be in electronic communication with the microprocessor so that the microprocessor may be able to perform calculations upon the sensed weather parameters and illustrate the weather information to the user on the display 12.

The display 12 may be constructed using a liquid crystal display (LCD), a light emitting diode (LED) screen or any other suitable type of display. The display 12 may include a current daily weather indicator 16 that illustrates whether the current weather is sunny, cloudy, rainy, or snowy based upon the received weather parameters. In addition, the digital weather station 10 may include a rolling weather indicator 18 that illustrates the forecasted weather for upcoming days of the week. For example, the digital weather station 10 may use the received weather parameters to illustrate whether the upcoming days of the week will be sunny, cloudy, rainy, or snowy.

The display 12 may also include any number of forecasting icons 20 that illustrate one or more of the weather parameters to the user in a numerical or graphical format. For example, the display 12 may include a temperature indicator 22 that illustrates the current indoor and outdoor temperatures. The display may also include a humidity indicator 24 that illustrates the current indoor and outdoor percent humidity. The display 12 may also include a pressure indicator 26 that illustrates the current barometric pressure and/or a rain accumulation indicator 28 that illustrates the amount of outdoor rain accumulation over a period of time. The display may further include a wind indicator 30 that illustrates the current outdoor wind speed and direction. The display may further include a UV indicator indicating data received from a UV sensor. The previous list is not exhaustive and the digital weather station 10 may include a forecasting icon for any number of other weather parameters not listed.

The digital weather station 10 may also include one or more health alert indicators 32 indicative of general health conditions in a given area. The digital weather station 10 may use one or more of the received weather parameters so as to alert the user as to a particular weather related occurrence. Also, each health alert indicator 32 may be capable of alerting a user either visually or audibly to a varying range of weather related occurrences. For example, the health alert indicators 32 may be used to alert the user to any occurrences in the outdoor weather that may be indicative of general health conditions. Alternatively, the health alert indicators 32 may be used so as to alert the user to any occurrences in the weather that may be beneficial to the user's health.

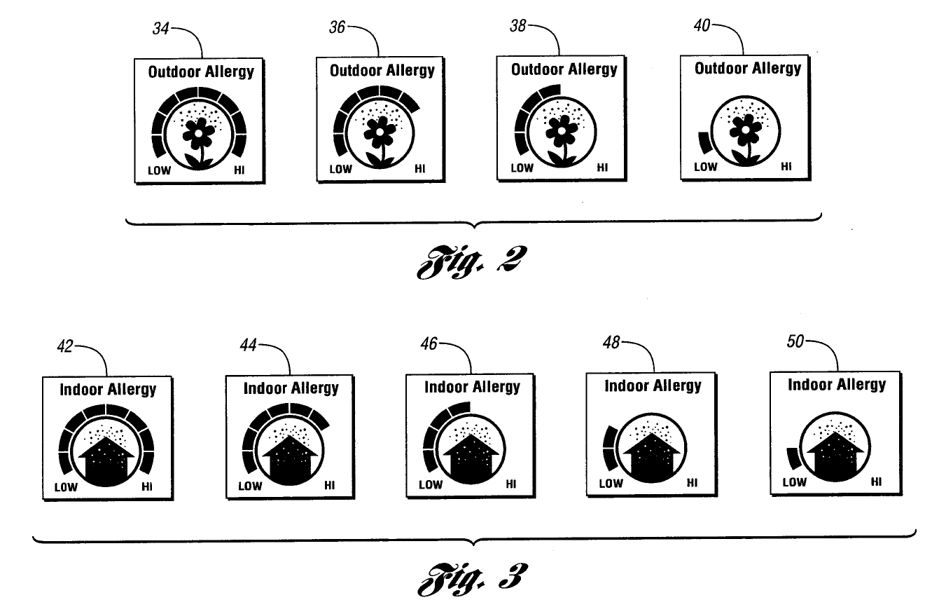

The health indicators 32 includes an outdoor allergy alert indicator. FIG. 2 shows a number of outdoor allergy alert indicators 34, 36, 38 and 40 according to one embodiment of the present invention. The digital weather station 10 may determine the presence of outdoor airborne allergens using one or more of the received weather parameters. The outdoor allergy alert indicator 33 may illustrate to the user the relative level of outdoor airborne allergens. For example, if the digital weather station 10 determines that the outdoor temperature is 60° F. or greater and the outdoor humidity is less than 30% or above 50%, then the outdoor allergy alert indicator 33 illustrates that outdoor airborne allergens are at a relatively high level 34. If the digital weather station 10 determines that the outdoor temperature is between 50° F. and 59° F. and the outdoor humidity is less than 30% or above 50%, then the outdoor allergy alert indicator 33 illustrates that outdoor airborne allergens are above a relatively moderate level 36. If the digital weather station 10 determines that the outdoor temperature is between 40° F. and 49° F. and the outdoor humidity is less than 30% or above 50%, then the outdoor allergy alert indicator 33 illustrates that the outdoor airborne allergens are at a relatively moderate level 38. If the digital weather station 10 determines that the outdoor temperature is less than 40° F. or the outdoor humidity is less than 30% or above 50%, then the allergy alert indicator 33 may illustrate that the outdoor airborne allergens are at a relatively low level 40.

The allergy alert indicator 33 may change between level indicators 34, 36, 38 and 40 based on a change in weather condition. In one embodiment, the weather parameters used in the allergen determination can be received by the weather at regular or intermittent intervals. The weather station 10 can use the received weather parameters to make the allergen determination at regular or intermittent intervals. At time one, the first allergen determination may indicate the relatively low level 40. Therefore, at time one, the outdoor allergy alert indicator 33 would be displayed as the relatively low level 40. At time two, the second allergen determination may indicate the relatively high level 34. At time two, the relatively high level 34 would supercede the relatively low level 40 for the outdoor allergy alert indicator 33. The relatively high level 34 would be displayed until another change is determined by the weather station 10. The process of changing the level indicators 34, 36, 38 and 40 for the outdoor allergy alert indicator 33 can be applied to one or more of the other health alert indicators 14 disclosed herein.

The health alert indicators 32 may also include an indoor allergy alert indicator 43. FIG. 3 shows a number of indoor allergy alert indicators 42, 44, 46, 48 and 50 according to one embodiment of the present invention. In one embodiment, one or more weather sensors are located inside a home or other building for obtaining the sensed weather parameters for use in the indoor allergy alert determination by the weather station 10. In this embodiment, the weather station 10 may include a switch so that the weather station 10 is informed that the sensors are located indoors. In another embodiment, one or more weather sensors are a part of the weather station 10, which is typically located indoors. Notwithstanding, in this embodiment, a switch can be utilized to inform the weather station 10 of its location, e.g., indoors or outdoors.

The digital weather station 10 may use the received weather parameters to determine the relative level of indoor airborne allergens. For example, if the digital weather station 10 determines that the indoor humidity is less than 30% or above 50% for more than the last running 24 hours, then the indoor allergy alert indicator 43 illustrates that the indoor airborne allergens are at a relatively high level 42. If the digital weather station 10 determines that the indoor humidity is below 30% or above 50% for more than the last running 12 hours but less than the last running 24 hours, then the indoor allergy alert indicator 43 illustrates that the indoor airborne allergens are at an above moderate relative level 44. If the digital weather station 10 determines that the indoor humidity is below 30% or above 50% for less than the last running 12 hours, then the indoor allergy alert indicator 43 illustrates that the indoor airborne allergens are at a relatively moderate level 46. If the digital weather station 10 determines the indoor humidity is between 31% and 49% for less than the last running 12 hours, then the indoor allergy alert indicator 43 illustrates that the indoor airborne allergens are at a below moderate low relative level 48. If the indoor humidity is detected to be between 31% and 49% for the last running 12 hours or longer, then the indoor allergy alert indicator 43 illustrates that the indoor airborne allergens are at a relatively low level 50.

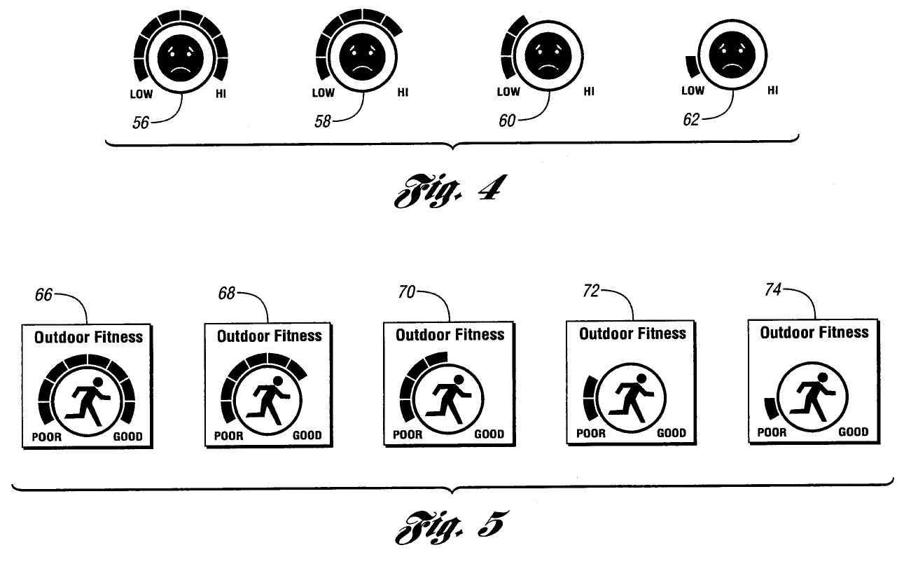

The health alert indicators 32 may also include an indoor allergy alert indicator 54. FIG. 4 shows a number of indoor allergy alert indicators 56, 58, 60 and 62 according to one or more embodiments of the present invention. The digital weather station 10 may use the received weather parameters to determine whether there is an increased probability that a person may experience joint discomfort.

For example, if the digital weather station 10 determines that (1) the outdoor barometric pressure change was greater than 0.18 inches of mercury (inHg) for more than the last running 3 hour period, (2) the outdoor rain accumulation was above one inch for the last running 5 or less days, or (3) there was an outdoor temperature change that is greater than 15° F. over the last running 2 day period, then the aches and pains indicator 54 illustrates that the susceptibility to joint discomfort is at a relatively high level 56.

If the digital weather station 10 determines that (1) the outdoor barometric pressure change is between 0.11 and 0.17 inHg over the last running 3 hour period, (2) the outdoor humidity was above 50% or below 30% for longer than the last running 2 days, (3) the outdoor rain accumulation was above 0.5 inches for the last running 3 or less days, or (4) the outdoor temperature change was equal to or greater than 10° F. for the last running 3 days or less, then the aches and pains indicator 54 illustrates that the susceptibility to joint discomfort is at an above moderate relative level 58.

If the digital weather station 10 determines that (1) the outdoor barometric pressure change was between 0.05 and 0.10 inHg over the last running 3 hour period, (2) the outdoor humidity was between 32% and 49% for between the last running 2 to 3 days, (3) no recordable outdoor rain accumulation has occurred for the last running 3 to 5 day period, or (4) the outdoor temperature change was less than 10° F. for the last running 3 to 5 day period, then the aches and pains indicator 54 illustrates that the susceptibility to joint discomfort is at a below moderate relative level 60.

If the digital weather station 10 determines that (1) the outdoor barometric change was 0.04 inHg or less for the last running 3 hour period, (2) the outdoor humidity was between 32% and 49% for the last running 3 days or more, (3) there is no recordable outdoor rain accumulation for a 5 day period, or (4) the outdoor temperature change was less than 10° F. over the last running 5 day period, then the aches and pains indicator 54 illustrates that the susceptibility to joint discomfort is at a low level 62.

As illustrated above, the digital weather station 10 determines each susceptibility level using an inclusive disjunctive combination of the weather related parameters. As such, there exists the possibility that the digital weather station 10 may determine that the aches and pains indicator 54 may fall within two separate susceptibility levels. For example, the digital weather station 10 may determine that the outdoor barometric pressure level is above 0.18 inHg and the outdoor humidity is between 32% and 49% for more than 3 days. The digital weather station 10 may determine that the aches and pain indicator 54 should illustrate that the level of susceptibility to joint discomfort is at both the relatively high level 56 and the relatively low level 62. In order to rectify such a disparity, the digital weather station 10 may be programmed so that the highest susceptibility level is illustrated. Thus, the digital weather station 10 may determine that the aches and pains indicator 54 should illustrate that the susceptibility to joint discomfort is at a relatively high level 56. It should be appreciated that in other embodiment, the lower level of susceptibility is illustrated.

The health alert indicators 32 may also include a fitness indicator 64. FIG. 5 shows a number of fitness indicators 66, 68, 70, 72 and 74 according to one embodiment of the present invention. The fitness indicator 64 may be used to illustrate the outdoor or indoor weather depending on the placement of the one or more sensors is relatively comfortable for exercising.

For example, if the digital weather station 10 determines that the outdoor humidity is between 31% and 59%, the outdoor temperature is between 50° F. and 75° F., and the outdoor barometric pressure change was 0.04 inHg or less over the last running 3 hour period, then the fitness indicator 64 illustrates that the conditions for workout training are at a relatively good level 66. If the temperature was between 50° F. and 75° F. for longer than the last running 12 hours, then the most current temperature is used in this determination.

If the digital weather station 10 determines that the outdoor humidity is between 31% and 59%, the outdoor temperature is between 50° F. and 75° F., and the outdoor barometric pressure change was between 0.05 and 0.1 inHg over the last running 3 hour period, then the fitness indicator 64 illustrates that the conditions for workout training are at an above moderate relative level 68. If the temperature was between 50° F. and 75° F. for longer than the last running 12 hours, then the most current temperature is used in this determination.

If the digital weather station 10 determines that the outdoor humidity is between 31% and 69%, the outdoor temperature is between 50° F. and 75° F. and the outdoor barometric pressure change is 0.1 inHg or less over the last 3 hour period, then the fitness indicator 64 illustrates that the conditions for workout training are at a relative moderate level 70. If the temperature was between 50° F. and 75° F. for longer than the last running 12 hours, then the most current temperature is used in this determination.

If the digital weather station 10 determines that the outdoor humidity is between 31% and 69%, the outdoor temperature is between 50° F. and 80° F. and the outdoor barometric pressure change is 0.10 inHg or less over the last running 3 hour period, then the fitness indicator 64 illustrates that the conditions for workout training are at a below moderate relative level 72.

If the digital weather station 10 does not detect one of the previous combination of conditions, then the fitness indicator 64 illustrates to the user that the conditions for workout training are at a relatively poor level 74.

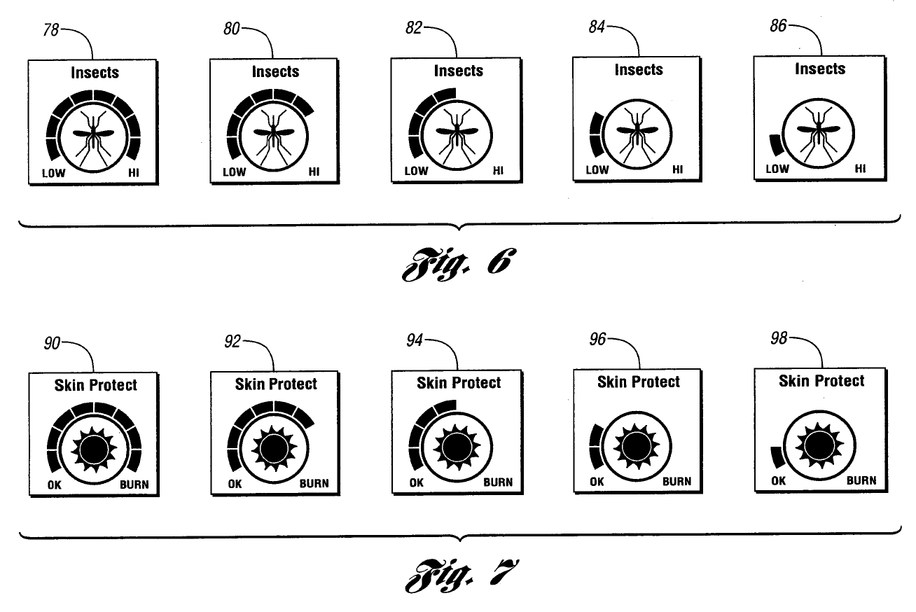

The health alert indicators 32 may also include a mosquito protection indicator 76. FIG. 6 shows a number of mosquito protection level indicators 78, 80, 82, 84 and 86 according to one embodiment of the present invention. The mosquito protection indicator may be used to predict how active mosquitos and/or other insects are in a particular area based on a variety of weather and time related parameters. The digital weather station 10 may predict the activity of mosquitos and/or insects within a particular area using the received weather parameters.

For example, if the digital weather station 10 determines that (1) the outdoor ultraviolet (UV) index is less than 4, (2) the outdoor wind speed is low, (3) the outdoor humidity is 65% or greater and (4) the outdoor temperature is between 61° F. and 95° F., then the mosquito protection indicator 76 illustrates that the mosquito and/or insect activity may be at a relatively high level 78. In one embodiment, a low wind speed is 10 MPH or less.

In one embodiment, a conventional UV sensor is utilized to measure the UV index. One such conventional UV sensor is a semiconductor based UV sensor that outputs an electrical current when exposed to UV, which is proportional to the UV intensity. The electrical current value can be mapped to a corresponding UV index. The mapping table is obtained through a calibration process with reference to a reliable UV measurement device.

If the digital weather station 10 determines that (1) the outdoor UV index is less than 4, (2) the outdoor wind speed is low, (3) the outdoor humidity is 60% or greater and (4) the outdoor temperature is between 51° F. and 95° F., then the mosquito protection indicator 76 illustrates that the mosquito and/or insect activity may be at an above moderate relative level 80.

If the digital weather station 10 determines that the (1) outdoor UV index is less than 4, (2) the outdoor wind speed is low, (3) the humidity is between 50% and 59% and (4) the outdoor temperature is between 51° F. and 95° F., then the mosquito protection indicator 76 illustrates that the mosquito and/or insect activity in the area is at a relatively moderate level 82.

If the digital weather station 10 determines that (1) the outdoor UV index is less than 4, (2) the outdoor wind speed is low, (3) the outdoor humidity is between 31% and 50%, and (4) the outdoor temperature is between 51° F. and 95° F., then the mosquito protection indicator 76 may illustrate that the mosquito and/or insect activity may be at a below moderate relative level 84.

If the digital weather station 10 does not detect one of the previous combinations of conditions, then the mosquito protection indicator 76 illustrates that the mosquito and/or insect activity in the area may be at a relatively low level 86.

The health alert indicators 32 may also include a skin protection indicator 88. FIG. 7 shows a number of skin protection level indicators 90, 92, 94, 96 and 98 according to one embodiment of the present invention. The skin protection indicator 88 may be used to predict the likelihood that the user may experience sunburn due to exposure to varying levels of UV radiation.

For example, if the digital weather station 10 determines that the outdoor UV index is greater than or equal to 10, then the skin protection indicator 88 illustrates that the possibility a sunburn may occur in the absence of any sun protection factor (SPF) protection is at a relatively high level 90. If the digital weather station 10 determines that the outdoor UV index is equal to or greater than 7 but less than 10, then the skin protection indicator 88 illustrates that the possibility a sunburn may occur in the absence of any SPF protection is at an above moderate relative level 92. If the digital weather station 10 determines that the outdoor UV index is equal to or greater than 5 but less than 7, then the skin protection indicator 88 illustrates that the possibility a sunburn may occur in the absence of any SPF protection is at a relatively moderate level 94. If the digital weather station 10 determines that the outdoor UV index is equal to or greater than 3 but less than 5, then the skin protection indicator 88 illustrates that the possibility a sunburn may occur in the absence of any SPF protection is at a below moderate relative level 96. If the digital weather station 10 does not detect one of the previous conditions, then the skin protection indicator 88 illustrates that the possibility a sunburn may occur in the absence of any SPF protection is at a relatively low level 98.

With reference back to FIG. 1, the digital weather station 10 may also include any number of control buttons 100. The control buttons 100 may be capable of programming the use of health alert indicators 32. For example, the control buttons 100 may be used to activate an audio or visual alert indicating to the user when the outdoor weather is optimal for workout training. Also, the control buttons 100 may be used to activate an audio or visual alarm indicating to the user when the indoor allergen levels are at an extremely high level. One or more embodiments of the present invention contemplates that the digital weather station 10 may be programmed so as to allow multiple audio and visual alerts so that the user may be alerted to multiple weather related health occurrences.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Thus, specific details disclosed are merely representative basis for teaching one skilled in the art to practice the present invention.

What is claimed is:

1. A digital weather station for displaying weather related information, the digital weather station comprising:
an electronic connection unit configured to receive weather data relating to a number of weather parameters;
a processing unit configured to process the weather data relating to the number of weather parameters to determine a number of weather related health indicators; and
a display unit configured to display the number of weather related health indicators.

2. The digital weather station of claim 1, further comprising a number of sensor units, configured to sense the weather data relating to the number of weather parameters at a location in which each of the number of sensor units is placed, and to transmit the sensed weather data to the electronic connection unit.

3. The digital weather station of claim 2, wherein each of the number of sensor units includes a sensor for sensing the weather data and a transmitter for transmitting the sensed weather data.

4. The digital weather station system of claim 2, wherein the processing unit is further configured to determine a relative level along a spectrum of levels for each of the number of weather related health indicators, and the display unit is further configured to display the relative level for the number of weather related health indicators.

5. The digital weather station system of claim 4, wherein the number of weather related health indicators includes an allergy alert indicator for indicating the relative level of airborne allergens at the location of each of the number of sensor units based on the sensed weather data received by the electronic connection unit.

6. The digital weather station system of claim 5, wherein the allergy alert indicator is an outdoor allergy alert indicator or an indoor allergy indicator.

7. The digital weather station system of claim 4, wherein the number of weather related health indicators includes an aches and pains indicator for indicating the relative level of susceptibility to joint discomfort based on the sensed weather data received by the electronic connection unit.

8. The digital weather station system of claim 4, wherein the number of weather related health indicators includes a fitness indicator for indicating the relative level of suitability of workout conditions at the location of each of the number of sensor units based on the sensed weather data received by the electronic connection unit.

9. The digital weather station system of claim 4, wherein the number of weather related health indicators includes an insect activity indicator for indicating the relative level of insect activity at the location of each of the number of sensor units based on the sensed weather data received by the electronic connection unit.

10. The digital weather station of claim 9, wherein each of the number of sensor units includes a UV sensor.

11. The digital weather station system of claim 4, wherein the number of weather related health indicators includes a skin protection indicator for indicating the relative level of susceptibility of sunburn based on the sensed weather data received by the electronic connection unit.

12. The digital weather station system of claim 1, wherein the display unit is further configured to display an icon representative of each of the number of weather related health indicators.

13. The digital weather station system of claim 4, wherein the relative level along a spectrum of levels for each of the number of weather related health indicators is represented as a number of bar segments.

14. The digital weather station system of claim 1, wherein the electronic connection unit is further configured to wirelessly receive sensed weather data.

15. A digital weather station system for displaying weather related information, the digital weather station comprising:
a base station including:
an electronic connection unit configured to receive weather data relating to a number of weather parameters;
a processing unit configured to process the weather data relating to the number of weather parameters to determine a number of weather related health indicators; and
a display unit configured to display the number of weather related health indicators; and
a number of remote sensors configured to sense the weather data relating to the number of weather parameters at a location in which each of the number of sensor units is placed.

16. The digital weather station system of claim 15, wherein one of the number of weather related health indicators is selected from the group consisting of: an allergy alert indicator, an aches and pains indicator, a fitness indicator, an insect activity indicator, and a skin protection indicator.

17. The digital weather station system of claim 16, wherein one of the number of weather related health indicators is the aches and pain indicator and the number of weather parameters includes barometric pressure change, rain accumulation and temperature change.

18. The digital weather station system of claim 16, wherein one of the number of weather related health indicators is the insect activity indicator, and the number of weather parameters includes UV index, wind speed, humidity and temperature.

19. The digital weather station system of claim 16, wherein one of the number of weather related health indicators is the skin protection indicator, and the number of weather parameters includes UV index.

20. A digital weather station for displaying weather related information, the digital weather station system comprising:
a receiver configured to receive weather data relating to a number of weather parameters;
a processor configured to process the number of weather parameters to determine a number of weather related health indicators; and
a display configured to display the number of weather related health indicators.
